(19) United States
(12) Patent Application Publication
(10) Pub. No.: US 2023/0360641 A1
(43) Pub. Date: Nov. 9, 2023

(54) EFFICIENT EMBEDDING FOR ACOUSTIC MODELS

(71) Applicant: Apple Inc., Cupertino, CA (US)

(72) Inventors: Daniel C. KLINGLER, San Jose, CA (US); Carlos M. AVENDANO, Campbell, CA (US); Jonathan HUANG, Pleasanton, CA (US); Miquel ESPI MARQUES, Cupertino, CA (US)

(21) Appl. No.: 17/736,959

(22) Filed: May 4, 2022

(51) Int. Cl. G10L 15/08; G10L 25/78; G10L 25/51; G06N 20/20

(52) U.S. Cl. CPC G10L 15/08; G10L 25/78; G10L 25/51; G06N 20/20

(57) ABSTRACT

The subject disclosure provides systems and methods for generating and storing learned embeddings of audio inputs to an electronic device. The electronic device may generate and store encoded versions of audio inputs and learned embeddings of the audio inputs. When a new audio input is obtained, the electronic device can generate an encoded version of the new audio input, compare the encoded version of the new audio input to the stored encoded versions of prior audio inputs, and if the encoded version of the new audio input matches one of the stored encoded versions of the prior audio inputs, the electronic device can provide a stored learned embedding that corresponds to the one of the stored encoded versions of the prior audio inputs to a detection model at the electronic device. The cached embeddings can be provided to locally trained models for detecting individual sounds using electronic devices.

### TECHNICAL FIELD

The present description relates generally to electronic devices including, for example, efficient embedding for acoustic models.

### BACKGROUND

Audio classification models can be trained to classify general categories of sounds using training datasets gathered by hundreds, thousands, or potentially millions of devices. However, audio classification can be computationally expensive to run in real time, particularly, for example, when attempting to classify multiple different sounds in an acoustic environment on an ongoing basis.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example device that may implement a system for efficient embedding for acoustic models in accordance with one or more implementations.

FIG. 3 illustrates an example sound detection operation by an electronic device in accordance with one or more implementations.

FIG. 4 illustrates another example sound detection operation that includes generation and storage of learned embeddings in accordance with one or more implementations.

FIG. 5 illustrates another example sound detection operation that includes generation and storage of learned embeddings in accordance with one or more implementations.

FIG. 6 illustrates another example sound detection operation using stored learned embeddings in accordance with one or more implementations.

FIG. 7 illustrates another example sound detection by an electronic device storing learned embeddings in accordance with one or more implementations.

FIG. 8 illustrates another example sound detection operation using stored learned embeddings in accordance with one or more implementations.

FIG. 9 illustrates an electronic device providing learned embeddings to another electronic device in accordance with one or more implementations.

FIG. 10 illustrates a flow diagram of an example process that can be performed by an electronic device for efficient embedding for acoustic models in accordance with one or more implementations.

FIG. 11 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Acoustic models, such as audio classification models, can be trained for detecting specific sounds. These acoustic models may be trained to generate learned embeddings of audio inputs and to generate labels of the audio inputs using the learned embeddings. However, in, for example, environments in which monitoring for multiple different sounds in an acoustic environment is desired, it can be inefficient (e.g., in terms of power usage, memory usage, and/or processing resources) to repeatedly generate embeddings by the various acoustic models for detecting the multiple different sounds.

Aspects of the subject technology, provide an efficient embedding system for acoustic models. In one or more implementations, an embeddings cache is provided that stores embeddings that can be provided to various different classifier models. The embeddings may be learned embeddings generated using a trained embeddings model, and may each correspond to an input audio sample. In accordance with one or more implementations, the embeddings may be stored in connection with an encoded version (e.g., a hash) of the corresponding input audio sample.

In accordance with one or more implementations, when a new input audio sample is obtained, if the embedding for that new input sample exists in the cache, the cached example can be provided to the downstream classification models (also referred to herein as sound detection models or detection models) for subsequent classification operations. If no embedding exists in the cache for the new input sample, a new embedding can be generated (e.g., and stored in the embeddings cache in association with a hash of the input sample).

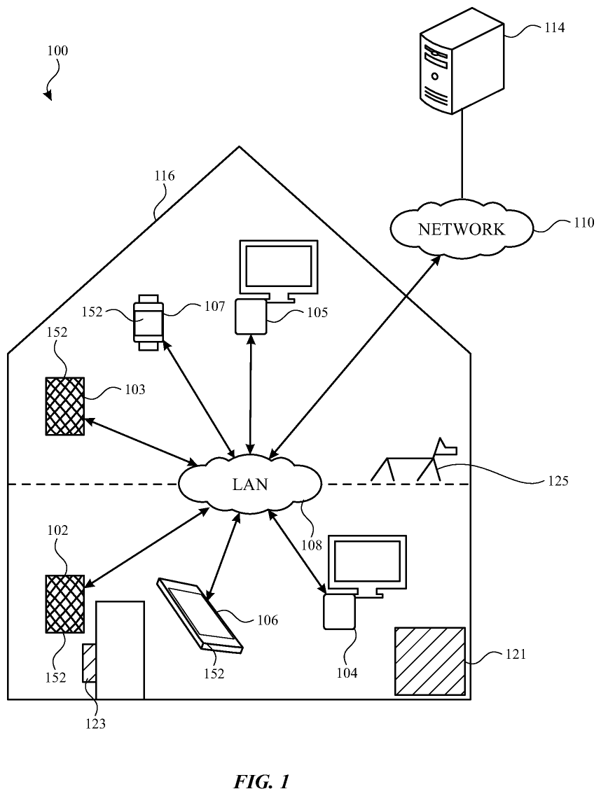

FIG. 1 illustrates an example network environment 100 that includes various devices in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes electronic devices 102, 103, 104, 105, 106 and 107 (hereinafter “the electronic devices 102-107”), a local area network (“LAN”) 108, a network 110, and one or more servers, such as server 114.

In one or more implementations, one, two, or more than two (e.g., all) of the electronic devices 102-107 may be associated with (e.g., registered to and/or signed into) a common account, such as an account (e.g., user account) with the server 114. As examples, the account may be an account of an individual user or a group account. In one or more implementations, the devices can be registered to different user accounts and the user accounts themselves may be grouped or otherwise associated with one another (e.g., user accounts of a family). As illustrated in FIG. 1, one or more of the electronic devices 102-107 may include a microphone 152 for capturing sound input to that device.

In one or more implementations, the electronic devices 102-107 may form part of a connected home environment 116, and the LAN 108 may communicatively (directly or indirectly) couple any two or more of the electronic devices 102-107 within the connected home environment 116. Moreover, the network 110 may communicatively (directly or indirectly) couple any two or more of the electronic devices 102-107 with the server 114, for example, in conjunction with the LAN 108. Electronic devices such as electronic device 106 and electronic device 105 may communicate directly over a secure direct connection in some scenarios, such as when electronic device 106 is in proximity to electronic device 105. Although the electronic devices 102-107 are depicted in FIG. 1 as forming a part of a connected home environment in which all of the devices are connected to the LAN 108, one or more of the electronic devices 102-107 may not be a part of the connected home environment and/or may not be connected to the LAN 108 at one or more times.

In one or more implementations, the LAN 108 may include one or more different network devices/network medium and/or may utilize one or more different wireless and/or wired network technologies, such as Ethernet, optical, Wi-Fi, Bluetooth, Zigbee, Powerline over Ethernet, coaxial, Ethernet, Z-Wave, cellular, or generally any wireless and/or wired network technology that may communicatively couple two or more devices.

In one or more implementations, the network 110 may be an interconnected network of devices that may include, and/or may be communicatively coupled to, the Internet. For explanatory purposes, the network environment 100 is illustrated in FIG. 1 as including electronic devices 102-107, and the server 114; however, the network environment 100 may include any number of electronic devices and any number of servers.

One or more of the electronic devices 102-107 may be, for example, a portable computing device such as a laptop computer, a smartphone, a smart speaker, a peripheral device (e.g., a digital camera, headphones), a digital media player, a tablet device, a wearable device such as a smartwatch or a band, a connected home device, such as a wireless camera, a router and/or wireless access point, a wireless access device, a smart thermostat, smart light bulbs, home security devices (e.g., motion sensors, door/window sensors, etc.), smart outlets, smart switches, and the like, or any other appropriate device that includes and/or is communicatively coupled to, for example, one or more wired or wireless interfaces, such as WLAN radios, cellular radios, Bluetooth radios, Zigbee radios, near field communication (NFC) radios, and/or other wireless radios.

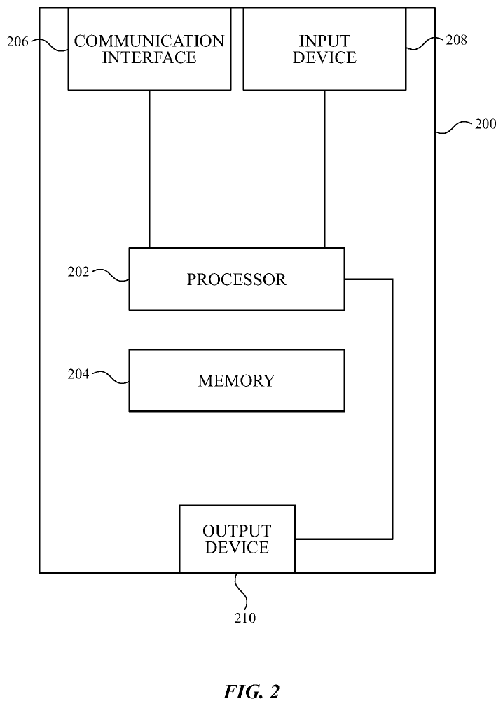

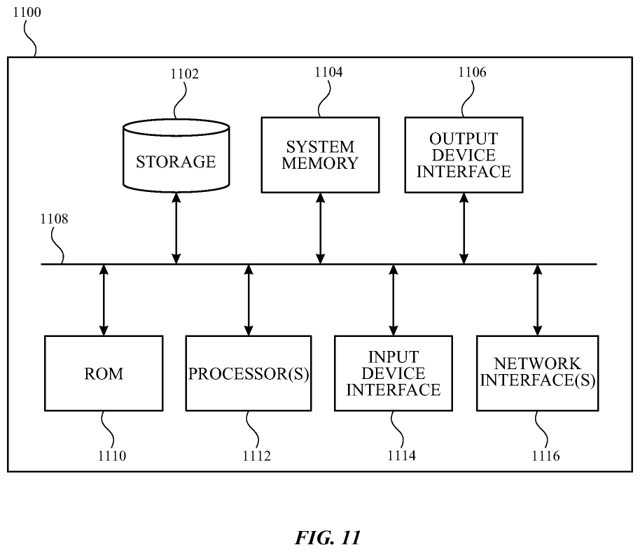

By way of example, in FIG. 1 each of the electronic devices 102-103 is depicted as a smart speaker, the electronic device 106 is depicted as a smartphone, the electronic device 107 is depicted as a smartwatch, and each of the electronic devices 104 and 105 is depicted as a digital media player (e.g., configured to receive digital data such as music and/or video and stream it to a display device such as a television or other video display). In one or more implementations, one or more of the electronic devices 104 and 105 may be integrated into or separate from a corresponding display device. One or more of the electronic devices 102-107 may be, and/or may include all or part of, the device discussed below with respect to FIG. 2, and/or the electronic system discussed below with respect to FIG. 11.

In one or more implementations, one or more of the electronic devices 102-107 may provide a system for training a machine learning model using training data, where the trained machine learning model is subsequently deployed to that electronic device and/or other one of the electronic device 102-107. Further, the electronic device 106 may provide one or more machine learning frameworks for training machine learning models and/or developing applications using such machine learning models. In an example, such machine learning frameworks can provide various machine learning algorithms and models for different problem domains in machine learning. In an example, one or more of the electronic devices 102-107 may include a deployed machine learning model that provides an output of data corresponding to a prediction or transformation or some other type of machine learning output.

As shown in FIG. 1, the network environment 100 may include and/or overlap with an acoustic environment in which one or more objects and/or devices may generate sounds. In the example of FIG. 1, a doorbell 123, an appliance 121 (e.g., a dishwasher, a washing machine, a dryer, a toaster, a blender, microwave oven, an alarm such as a smoke alarm, a fire alarm, a burglar alarm, or a carbon monoxide alarm, etc.), and a pet 125 (e.g., a dog, a cat, a bird, etc.) are shown as objects that may generate sounds, for illustrative purposes. In various use cases, objects and/or devices may generate sounds that are specifically intended as alert sounds (e.g., the ring of a doorbell, an alarm sound from an alarm, or a buzzer or bell that sounds at the end of an appliance cycle). In other use cases, objects and/or devices may generate sounds as part of the operation of the object and/or device. For example, the sound of an appliance running, or the sound of a garage door opening may be sounds that are generated as part of the normal operation of an object or device.

In one or more implementations, one of more of the electronic devices 102-107 may be configured to detect one or more specific sounds (e.g., the sound of the doorbell 123, a sound associated with an appliance 121, a sound of an object or device in operation or ceasing operation, a smoke alarm sound, a fire alarm sound, a carbon monoxide alarm sound, or the sound of a pet 125) and to generate an alert, a notification, or other output when a specific sound is detected. For example, one or more of the electronic devices 102-107 may include one or more machine-learning models trained as sound classifiers. For example, one or more of the electronic devices 102-107 may include a pre-trained general sound classifier trained at another device or server and deployed to the electronic device (e.g., for general detection of general sounds, and which may not be able to detect to the specific sounds generated in a specific acoustic environment). As another example, one or more of the electronic devices 102-107 may use one or more detections models (also referred to as classification models or sound detection models), trained at that electronic device using audio samples obtained by that electronic device and/or one or more others of the electronic devices 102-107.

In one or more implementations, one or more of the electronic devices 102-107 may include an embedding model configured to generate learned embeddings from audio inputs to the embedding model. In one or more implementations, one or more of the electronic devices 102-107 may include an embeddings cache that stores one or more learned embeddings. The learned embeddings may be stored in connection with respective encoded versions of the audio inputs from which the learned embeddings were generated. By storing encoded versions of the audio inputs and/or learned embeddings of the audio inputs, without storing unencoded audio samples, the privacy of users of the electronic devices 102-107 and/or other persons in the environment of the electronic devices 102-107 can be protected. For example, the encoded versions of the audio samples and/or the learned embeddings can be unrecognizable to a human eye or ear, and thus cannot be used to identify individuals or voices that may be present in the acoustic environment of the electronic devices 102-107. In one or more implementations, learned embeddings may be generated by one or more of the electronic devices 102-107 and provided to one or more others of the electronic devices 102-107, as described in further detail hereinafter. In some aspects, to protect the user's privacy, the encoded version of the audio inputs and/or learned embeddings are only stored locally on electronic devices 102-107, without any back-ups to remote servers. Moreover, because the embedding model is specifically trained to classify sounds of objects, the embedding model that generates the learned embeddings may be unable to extract the identity of a speaker or spoken words (e.g., which could only be identified by a different kind of model with different training data and objectives), thereby further protecting the user's privacy.

In one or more implementations, the server 114 may be configured to perform operations in association with user accounts such as: storing data (e.g., user settings/preferences, files such as documents and/or photos, etc.) with respect to user accounts, sharing and/or sending data with other users with respect to user accounts, backing up device data with respect to user accounts, and/or associating devices and/or groups of devices with user accounts.

One or more of the servers such as the server 114 may be, and/or may include all or part of the device discussed below with respect to FIG. 2, and/or the electronic system discussed below with respect to FIG. 11. For explanatory purposes, a single server 114 is shown and discussed herein. However, one or more servers may be provided, and each different operation may be performed by the same or different servers.

FIG. 2 illustrates an example device that may implement a system for sound detection in accordance with one or more implementations. For example, the device 200 of FIG. 2 can correspond to any of the electronic devices 102-107 and/or the server 114 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The device 200 may include a processor 202, a memory 204, a communication interface 206, an input device 208, and an output device 210. The processor 202 may include suitable logic, circuitry, and/or code that enable processing data and/or controlling operations of the device 200. In this regard, the processor 202 may be enabled to provide control signals to various other components of the device 200. The processor 202 may also control transfers of data between various portions of the device 200. Additionally, the processor 202 may enable implementation of an operating system or otherwise execute code to manage operations of the device 200.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

In one or more implementations, in a case where the device 200 corresponds to one of the electronic devices 102-107, the memory 204 may store one or more sound detection models, encoded versions of audio inputs or sounds, learned embeddings of one or more audio inputs or sounds, and/or information associated with one or more user accounts for one or more applications and/or services, using data stored locally in memory 204. Moreover, the input device 208 may include suitable logic, circuitry, and/or code for capturing input, such as audio input, sound input remote control input, touchscreen input, keyboard input, etc. The output device 210 may include suitable logic, circuitry, and/or code for generating notifications, alerts and/or other output, such as audio output, display output, light output, and/or haptic and/or other tactile output (e.g., vibrations, taps, etc.).

The communication interface 206 may include suitable logic, circuitry, and/or code that enables wired or wireless communication, such as between any of the electronic devices 102-107 and/or the server 114 over the network 110 (e.g., in conjunction with the LAN 108). The communication interface 206 may include, for example, one or more of a Bluetooth communication interface, a cellular interface, an NFC interface, a Zigbee communication interface, a WLAN communication interface, a USB communication interface, or generally any communication interface.

In one or more implementations, one or more of the processor 202, the memory 204, the communication interface 206, the input device 208, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

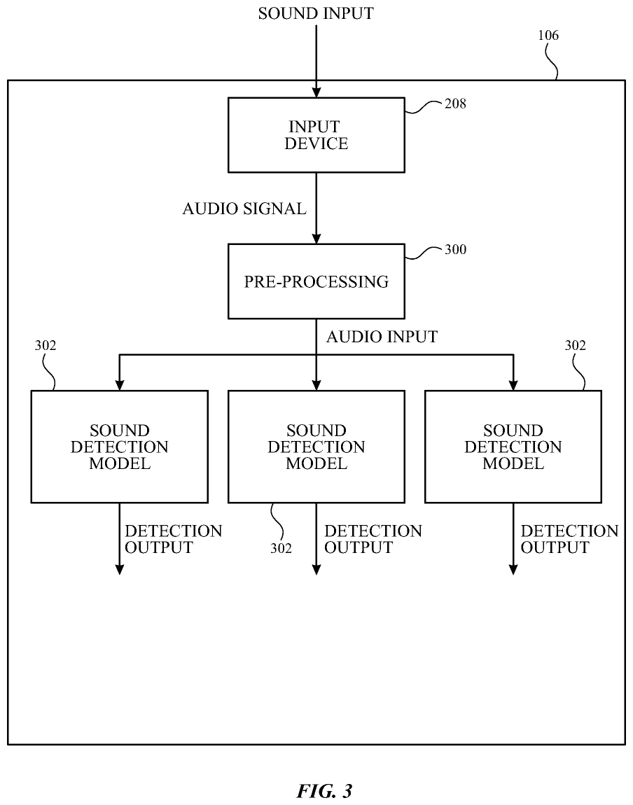

FIG. 3 illustrates an example processing operation that may be performed by an electronic device for sound detection. In the example of FIG. 3, a sound input (e.g., including one or more sounds occurring in the environment of an electronic device such as electronic device 106) may be received by the input device 208 (e.g., a microphone of the device). As shown, an audio signal corresponding to the sound input (e.g., a digitized and/or filtered version of the sound input) may be provided to a pre-processing engine 300 at the electronic device. In one or more implementations, the audio signal may include distributed representations of periodic or streaming audio captured by the input device 208 (e.g., in an operational mode in which the electronic device 106 is “listening” for one or more specific sounds for which one or more sound detection models 302 at the electronic device 106 have been trained).

The pre-processing engine 300 may perform one or more pre-processing operations on the audio signal. For example, the pre-processing operations may include performing a frequency transform (e.g., a Fourier transform) that transforms an audio signal in the time domain to an audio signal in a frequency domain. In one or more implementations, the pre-processing operations may include combining frequency domain signals to generate a spectrogram.

In the example, of FIG. 3, the pre-processed audio signal (e.g., one or more spectrograms) may be provided as audio input to one or more sound detection models 302 at the electronic device 106. In the example of FIG. 3, each of the sound detection models 302 is trained to transform the audio input into a (e.g., relatively low-dimensional) sound embedding and to generate a detection output based on the embedding generated by that model. In various examples, the detection output may be a binary output (e.g., detected or not detected) for a specific sound for which that model has been trained, or may be a label of a detected sound for which that model has been trained. As illustrated in FIG. 3, a single electronic device may include multiple sound detection models 302. For example, the various sound detection models 302 may be associated with various different applications at the electronic device and/or multiple sound detection models may be associated with a single application at the electronic device. As one example, a first sound detection model may be trained to detect a trigger phrase for a voice assistant application, and second and third detection models may be trained to detect different respective sounds (e.g., alarm sounds, appliance sounds, doorbell sounds, crying, coughing, etc.) for an listening-assist application at the electronic device that aids a user in listening for various environmental sounds. As another example, a sound detection model at the electronic device may include a multi-label model trained to detect any of several sounds in sound inputs to the electronic device.

In the example of FIG. 3, each of the sound detection models 302 is configured to receive the audio input and to generate a detection output based on an internally generated embedding of the sound input. However, because many of the computations for generating the embeddings of the sound input by the various sound detection models can be overlapping or duplicative, the arrangement of FIG. 3 can be computationally inefficient. This can be particularly true, for example, when a sound detection model is continually listening for a particular sound or sounds and/or in computational environments in which multiple sound detection models are running on the same device and/or in the same acoustic environment.

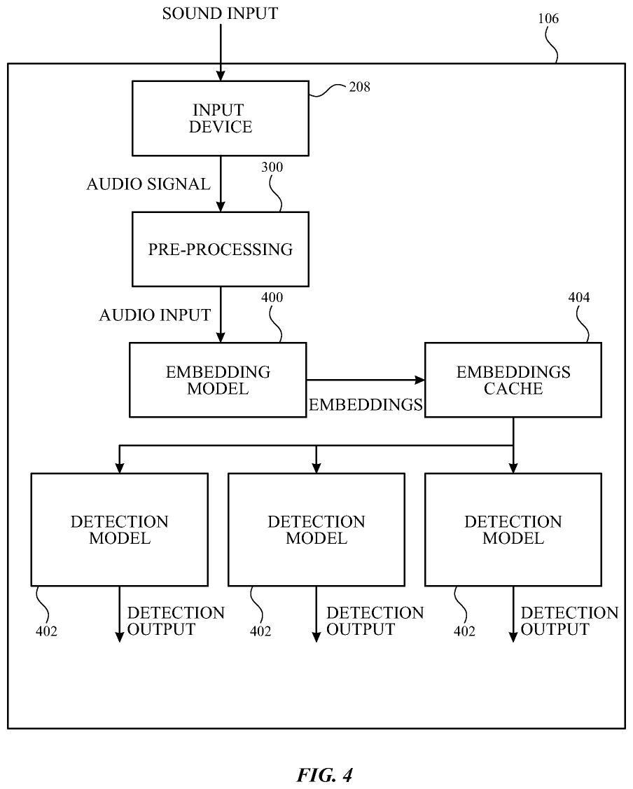

FIG. 4 illustrates an example implementation of electronic device 106 in which the electronic device includes an embedding model 400, an embeddings cache 404, and a detection model 402. For example, various detection models 402 may be associated with various different applications at the electronic device and/or multiple sound detection models may be associated with a single application at the electronic device. As one example, a first detection model 402 may be configured to received one or more embeddings, generated by the embedding model 400, from the embeddings cache 404 and may be trained to detect a trigger phrase for a voice assistant application. In an example, second and/or third detection models may be configured to received one or more embeddings, generated by the embedding model 400, from the embeddings cache 404 and may be trained to detect different respective sounds (e.g., alarm sounds, appliance sounds, doorbell sounds, crying, coughing, etc.) for an listening-assist application at the electronic device. As another example, a detection model 402 at the electronic device may include a multi-label model configured to received one or more embeddings, generated by the embedding model 400, from the embeddings cache 404 and trained to detect any of several sounds in sound inputs to the electronic device. In various examples, the detection output from a detection model 402 may be a binary output (e.g., detected or not detected) for a specific sound for which that model has been trained, or may be a label of a detected sound for which that model has been trained.

In the example, of FIG. 4, the embeddings cache 404 may store a number of recently generated embeddings, generated by the embedding model 400, for a corresponding number of recent sound inputs. As an example, the embeddings cache 404 may be implemented as a circular queue or a ring buffer that stores the last N embeddings generated over a period of time. For example, in one or more implementations, the electronic device 106 may obtain audio samples periodically (e.g., every 10 ms, every 100 ms, every second, every minute, etc.), and may generate and store embeddings for the most recent five, ten, twenty, one hundred, or other number N audio samples. In the example of FIG. 4, the embedding model 400 is separate from the detection models 402. In one or more other implementations, the embedding model 400 may be integrated into one of the detection models 402 that is configured to output generated embeddings to the embeddings cache 404 for storage and/or use by other detection models.

In one or more implementations, each of the detection models 402 may be configured to receive a number M of the N stored embeddings in the embeddings cache 404 and to generate a corresponding detection output based on the number M of the stored embeddings. In this way, real-time sound detection can be performed in parallel by multiple sound detectors (e.g., detection models 402) at the electronic device 106 using a desired number of recent embeddings, without each of the detection models having to compute the embeddings for the incoming real-time audio inputs.

In one or more implementations, when a new embedding is generated by the embedding model 400 for storage in the embeddings cache 404, the oldest stored embedding in the embeddings cache 404 may be deleted from the electronic device 106 and replaced by the new embedding. In this way, the electronic device 106 can, in a manner that protects the privacy of the user of the electronic device and/or any other people that may be in the vicinity of the electronic device 106, generate an embeddings cache 404 that may be used for efficient sound detection by multiple sound detectors (e.g., detection models 402) the electronic device 106. For example, by storing the learned embeddings without storing the corresponding audio inputs, and by continually deleting older embeddings, the electronic device 106 can be configured to efficiently provide embeddings to the detection models without permanently storing user-identifiable data associated with audio inputs. Moreover, deleting the older embeddings can also be advantageous in freeing memory resources, which can also reduce power consumption and improve battery life.

In addition to, or alternatively to, simply providing a number M of the most recent embeddings stored in the embeddings cache 404 to multiple detection models 402, the electronic device 106 can also selectively provide stored embeddings to one or more detection models 402 at the device when the electronic device determines that an embedding of a new audio input or sound input already exists in the embeddings cache. This can be useful for real-time sound detection operations and/or offline sound detection operations, such as for detecting sounds in stored audio files (e.g., including video files with audio content).

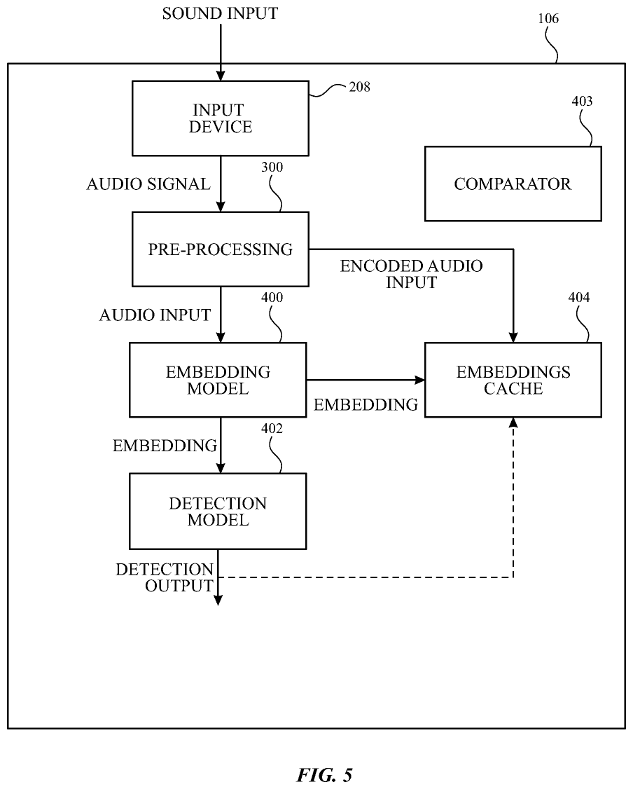

FIG. 5 illustrates an example processing operation that may be performed by an electronic device for sound detection, in accordance with one or more implementations. In the example of FIG. 5, the electronic device 106 is provided with the embedding model 400, a detection model 402, the embeddings cache 404, and a comparator 403.

As shown in FIG. 5, when a sound input is received by the input device 208, a resulting audio signal (e.g., a digitized and/or filtered audio signal) is provided to the pre-processing engine 300. For example, the pre-processing engine generates an audio input (e.g., a spectrogram) and provides the audio input to the embedding model 400. The embedding model 400 is trained to receive the audio input and to generate an embedding (e.g., embedding vector) from the audio input. The embedding model 400 may be implemented as a convolutional neural network, a recurrent neural network or other neural network or machine learning model architecture. The embedding model 400 may generate the embedding by mapping the relatively high dimensional audio input to a (e.g., relatively low dimensional) vector of numbers. Because the embedding model 400 is trained to generate the embeddings based on training audio inputs, the embedding model 400 generates embeddings for similar sounds that are closer together, in the embedding space of the embedding model, than embeddings for substantially different sounds. For example, embeddings of various dog barks will be closer to each other in the embedding space than embeddings of a dog bark and a doorbell.

As shown, the embedding model 400 may generate a learned embedding of the audio input and provide the learned embedding to the detection model 402. As in FIG. 4, the detection model 402 may be configured to receive the embedding as an input to the model and trained to generate a detection output based on the input embedding.

As shown in FIG. 5, the embedding model 400 may also provide the learned embedding to the embeddings cache 404 for storage at the electronic device 106. As shown, the pre-processing engine 300 may also generate an encoded version of the audio signal from the input device 208 and provide encoded audio input to the embeddings cache 404 e.g., or other storage at the electronic device) for storage in connection with the learned embedding for the audio input.

In this way, the electronic device 106 can, in a manner that protects the privacy of the user of the electronic device and/or any other people that may be in the vicinity of the electronic device 106, generate an embeddings cache 404 that may be used for real-time and/or subsequent efficient sound detection by the electronic device 106. By storing the encoded versions of audio inputs in connection with the learned embeddings for those inputs, the electronic device 106 can be configured to efficiently provide embeddings to the detection model, when sounds for which embeddings have already been generated are received in future sound input by the input device 208.

As illustrated in FIG. 5, in one or more implementations, the detection output (e.g., a label) generated by the detection model 402 for an embedding may also be provided to, and stored by, the embeddings cache, so that a previously determined label can also be identified based on a stored encoded version of an audio input.

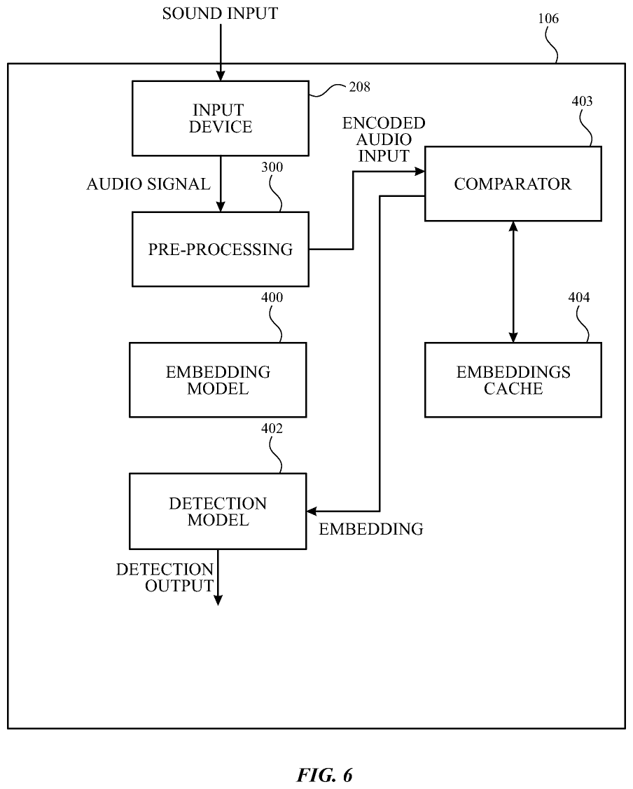

FIG. 6 illustrates an example operation of the electronic device 106 for sound detection using the embedding(s) stored in the embeddings cache (e.g., by the operations of FIG. 5), in accordance with one or more implementations. As shown in FIG. 6, the electronic device 106 may (e.g., after the process of FIG. 5 in which a learned embedding of at least a first audio sample is generated by a first machine-learning (ML) model, such as the embedding model 400, and stored in the embeddings cache 404 in connection with an encoded version of the first audio input) obtain another audio sample (e.g., a second audio sample corresponding to a second sound input) using a microphone (e.g., input device 208) of the device.

As shown, the pre-processing engine 300 may generate an encoded version of the second audio sample. The pre-processing engine 300 may provide the encoded version of the second audio sample to the comparator 403. In this example, the comparator 403 may compare the encoded version of the second audio sample with the encoded version of the first audio sample. For example, the comparator 403 may receive the encoded version of the second audio sample, obtain the encoded version of the first audio sample and any other encoded versions of other previous audio samples that are stored in the embeddings cache 404, and compare the encoded version of the second audio sample with the encoded version of the first audio sample and/or any other obtained encoded versions of other previous audio sample.

In the example of FIG. 6, the comparator 403, responsive to a determination that the encoded version of the second audio sample matches the encoded version of the first audio sample, obtains the learned embedding of the first audio sample from the embeddings cache 404 and provides the learned embedding of the first audio sample to the detection model 402 (e.g., instead of the embedding model 400 computing a new embedding of the second audio sample). As shown, this allows the electronic device 106 to efficiently process the second audio sample by bypassing the embedding model 400 and allowing the detection model 402 to operate on a previously generated learned embedding.

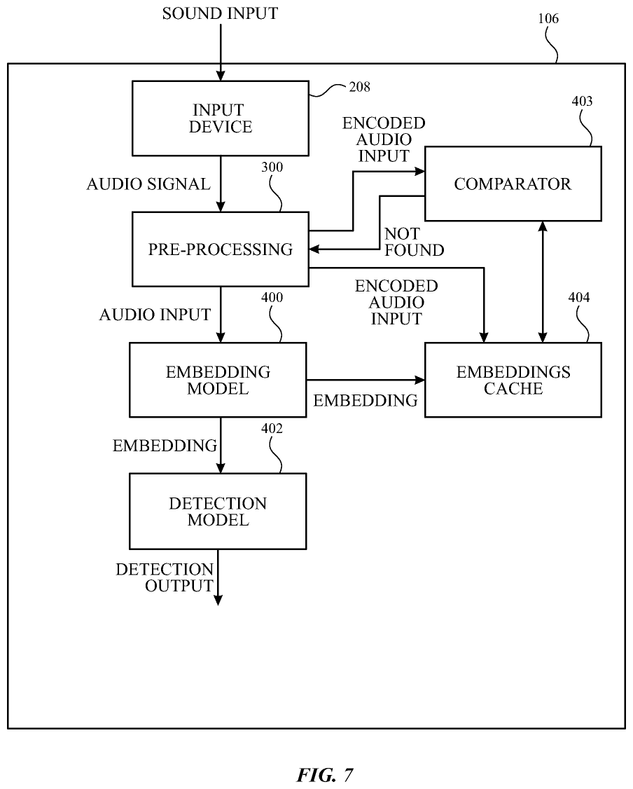

In the example of FIG. 6, the comparator 403 finds a match in the embeddings cache 404 for an encoded version of a new audio input. FIG. 7 illustrates an example in which the comparator 403 does not find a match in the embeddings cache 404 for an encoded version of a new audio input. As shown, when the comparator 403 receives an encoded audio input for a new sound input to the electronic device and does not find a match for the encoded audio input for the new sound input to the electronic device, the comparator 403 may provide a notification to the pre-processing engine 300 that a match was not found. Responsively, the pre-processing engine 300 may provide the audio input to the embedding model 400, and the embedding model 400 may generate a new embedding for the new sound input, and provide the new embedding to the detection model 402 for generation of a detection output. As shown, the embedding model 400 may also provide the new embedding to the embeddings cache 404 for storage along with an encoded version of the new audio input provided to the embeddings cache by the pre-processing engine 300. In one or more implementations, if the embeddings cache is full, the new embedding of the new sound input may cause deletion of an existing embedding stored in the embeddings cache. For example, the embeddings cache may be implemented as a ring buffer in which an oldest embedding is replaced with newest embedding, or as a least recently used (LRU) buffer in which a least recently used one of the embeddings is replaced with the newest embedding.

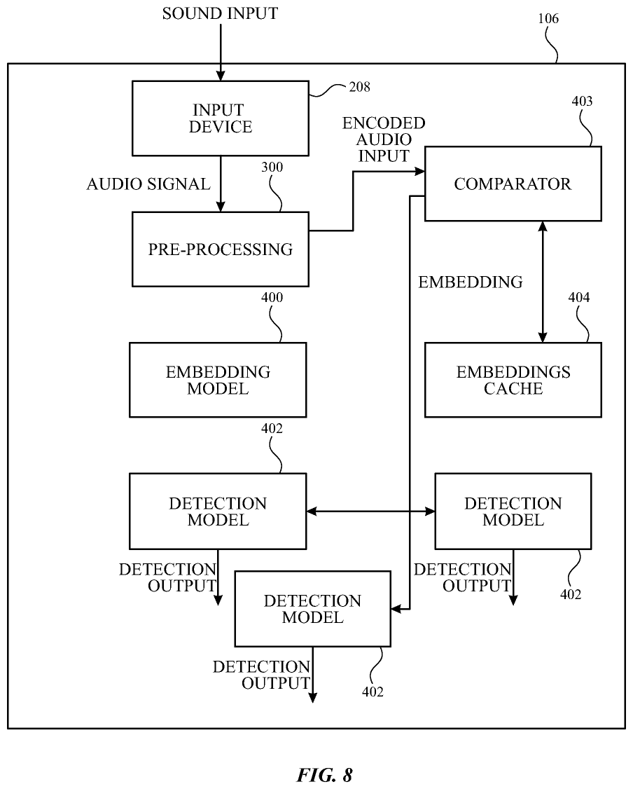

In the example of FIGS. 6 and 7, the embedding, whether from the embedding model 400 or the embeddings cache 404, is provided to a single detection model 402. As shown in FIG. 8, when the comparator 403 identifies a stored encoded version of an audio input that matches an encoded version of a new audio input, the comparator 403 may obtain the stored embedding for the identified stored encoded version from the embeddings cache 404, and provide the obtained embedding to more than one detection model 402 at the electronic device (e.g., for parallel sound detection operation on the same embedding(s) in the example of FIG. 8).

Although the examples of FIGS. 5-8 show a comparator that is separate from the pre-processing engine 300, this is merely illustrative and, in other implementations, the comparator may be formed as a portion of the pre-processing engine 300 or vice versa. In various implementations, the pre-processing engine 300, the comparator 403, the embedding model 400, and/or the detection models 402 may be implemented in software, hardware, or a combination thereof.

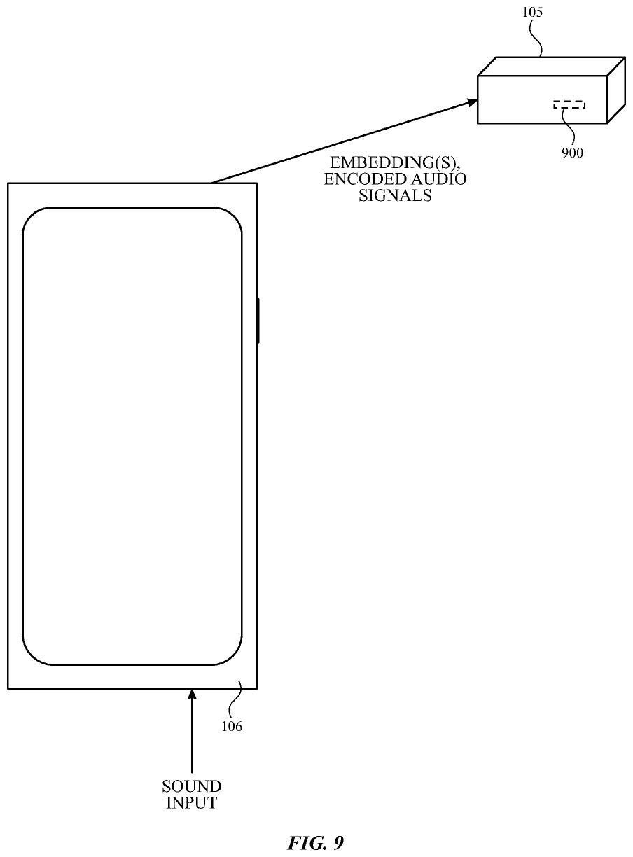

FIG. 9 also illustrates how, in one or more implementations, learned embeddings and/or encoded versions of audio samples generated at one device (e.g., the electronic device 106) can be shared with another device (e.g., the electronic device 105). As illustrated in FIG. 9, the electronic device 105 may include a machine learning model 900, such as a sound detection model that is trained to recognize one or more sounds. However, the electronic device 105 may not include a microphone, and/or may not have the processing power, memory, or other resources for generating learned embeddings. In the example of FIG. 9, the electronic device 106 receives a sound input, generates an encoded version of the sound input and/or generates a learned embedding of the sound input using a machine learning model such as the embedding model 400, and provides the encoded version of the sound input and/or the learned embedding of the sound input to the electronic device 105. In one or more implementations, when a new sound input is received by the electronic device 106, the electronic device 106 can generate an encoded version of the new sound input, compare the encoded version of the new sound input with the previously generated encoded version of the previous sound input and, if a match is detected, provide an indication to the electronic device 105 to provide the previously provided learned embedding to the machine learning model 900 for classification of the new input sound. In one or more other implementations, when a new sound input is received by the electronic device 106, the electronic device 106 can generate an encoded version of the new sound input, compare the encoded version of the new sound input with the previously generated encoded version of the previous sound input and, if a match is detected, provide the previously received learned embedding to the machine learning model 900 for classification of the new input sound.

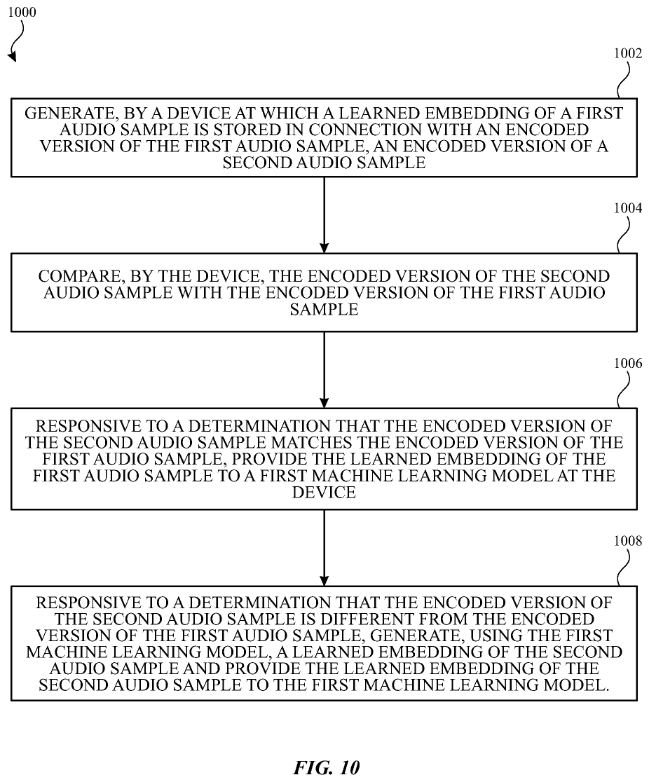

FIG. 10 illustrates a flow diagram of an example process 1000 for operating an electronic device based on cached embeddings, such as for detecting sounds with the electronic device in accordance with one or more implementations. For explanatory purposes, the process 1000 is primarily described herein with reference to the electronic device 106 of FIG. 1. However, the process 1000 is not limited to the electronic device 106 of FIG. 1, and one or more blocks (or operations) of the process 1000 may be performed by one or more other suitable devices. Further for explanatory purposes, the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

At block 1002, a device (e.g., electronic device 106) at which a learned embedding of a first audio sample is stored in connection with an encoded version of the first audio sample (e.g., in an embeddings cache such as embeddings cache 404), may generate an encoded version of a second audio sample. For example, the audio sample may be a sample sound input obtained by a microphone (e.g., a microphone 152) that is installed in the device or a microphone that is communicatively coupled (e.g., by a wired or wireless connection) to the device. In various use cases, the sound input may correspond to the sound of an appliance, a pet, a siren, an alarm, or another sound in an acoustic scene or environment around the electronic device. In various use cases, the sound input may include a sound that was previously enrolled for detection by the electronic device 106 by training a detection model at the electronic device. As an example, the encoded version of the first audio sample may be a hash of the first audio sample or any other encoding of the first audio sample. For example, generating the encoded version of the first audio sample may include generating a hash of the first audio sample. As an example, the encoded version of the second audio sample may be a hash of the second audio sample or any other encoding of the second audio sample. In various implementations, the sound input may be converted (e.g., transformed) into frequency space prior to encoding (e.g., hashing) of the sound input.

At block 1004, the device (e.g., a comparator 403) may compare the encoded version of the second audio sample with the encoded version of the first audio sample. For example, comparing the encoded version of the second audio sample with the encoded version of the first audio sample may include performing a hash comparison of the encoded version of the second audio sample and the encoded version of the first audio sample (e.g., by comparing corresponding values of hashes of the first audio sample and the second audio sample, and/or by determining whether the encoded version of the first audio sample and the encoded version of the second audio sample contain the same number of keys and whether each of one or more key-value pairs of the encoded version of the first audio sample is equal to the corresponding elements in the encoded version of the second audio sample).

At block 1006, the device may, responsive to a determination that the encoded version of the second audio sample matches the encoded version of the first audio sample, provide the learned embedding of the first audio sample to a first machine learning model (e.g., a detection model 402) at the device (e.g., as discussed herein in connection with FIG. 6 and/or FIG. 8). In one or more implementations, the first machine learning model may be a multi-label classifier (e.g., a machine learning model trained to identify and label multiple different sounds present in an audio input). In one or more other implementations, the first machine learning model may be a binary classifier that outputs a binary indication of whether a particular sound is detected or not.

At block 1008, responsive to a determination that the encoded version of the second audio sample is different from the encoded version of the first audio sample, the device may generate, using a second machine learning model (e.g., the embedding model 400), a learned embedding of the second audio sample and provide the learned embedding of the second audio sample to the first machine learning model (e.g., the detection model). In one or more implementations, the device may also store a label, generated by the first machine learning model, for the first audio sample in connection with the encoded version of the first audio sample. In one or more implementations, the stored label and the stored encoded version of the first audio sample can be used to identify another audio signal containing the same sound as the first audio sample, without again operating the detection model.

In one or more implementations, the process 1000 may also include, responsive to the determination that the encoded version of the second audio sample is different from the encoded version of the first audio sample, storing the learned embedding of the second audio sample (e.g., in the embeddings cache 404), generating an encoded version of the second audio sample, and storing the learned embedding of the second audio sample in connection with the encoded version of the second audio sample (e.g., in the embeddings cache 404).

In one or more implementations, prior to generating the encoded version of the second audio sample at block 1002, the device may obtain, from a microphone of the device, the first audio sample, and generate, using the second machine learning model at the device, the learned embedding of the first audio sample. The device (e.g., pre-processing engine 300) may also generate the encoded version of the first audio sample. The device may also store the encoded version of the first audio sample and the learned embedding of the first audio sample (e.g., in an embeddings cache 404) at the device.

In one or more implementations, the process 1000 may also include, prior to generating the encoded version of the second audio sample at block 1002, providing the learned embedding of the first audio sample to a third machine learning model (e.g., the same or another detection model 402) at the device, and obtaining, by the device, a label (e.g., a detection output) for the first audio sample based on an output of the third machine learning model. For example, the third machine learning model may be the same as the first machine learning model or may be different from the first machine learning model. In one illustrative example, the first machine learning model may be a fire alarm detector (e.g., may be a neural network that has been trained as a fire alarm detector) and the third machine learning model may be a carbon monoxide alarm detector (e.g., may be a neural network that has been trained as a carbon monoxide alarm detector).

In one or more implementations, the process 1000 may also include deleting, after a period of time, the learned embedding of the first audio sample and the encoded version of the first audio sample from the device. For example, the device may include an embeddings cache, such as embeddings cache 404, that is managed as a rolling or loop buffer in which, once a predetermined number of learned embeddings are stored in the cache, a new incoming embedding causes the oldest embedding in the cache to be deleted from the cache. In another example, the device may include an embeddings cache, such as embeddings cache 404, that is managed as a LRU buffer in which, once a predetermined number of learned embeddings are stored in the cache, a new incoming embedding causes a least recently used embedding in the cache to be deleted from the cache. In this way, the privacy of the user of the electronic device and/or any persons in the vicinity of the electronic device during acquisition of audio samples can be protected by preventing long-term storage of user-identifiable information relating to audio samples (e.g., in addition to the privacy protections provided by storing the encoded versions and learned embeddings of audio samples, rather than storing the audio samples themselves).

In one or more implementations, the process 1000 and/or another process performed by the device may include continually updating an embeddings cache (e.g., embeddings cache 404) at the electronic device to include a number N of recent learned embeddings generated by an embedding model (e.g., embedding model 400) at the device, and providing one or more of the N recent learned embeddings to multiple detection models (e.g., detection models 402) at the electronic device and/or another device (e.g., with or without storing and/or comparing encoded versions of the audio inputs from which the embeddings were generated.

As described above, one aspect of the present technology is the gathering and use of data available from specific and legitimate sources for generating and using an embeddings cache, such as for sound detection. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for generating and using an embeddings cache, such as for sound detection. Accordingly, use of such personal information data may facilitate authentication operations. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of generating and using an embeddings cache, such as for sound detection, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 11 illustrates an electronic system 1100 with which one or more implementations of the subject technology may be implemented. The electronic system 1100 can be, and/or can be a part of, one or more of the electronic devices 102-107 and/or the server 114 shown in FIG. 1. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a floppy disk, flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input and output device interfaces 1114 and 1106. The input device interface 1114 enables a user to communicate information and select commands to the electronic system 1100. Input devices that may be used with the input device interface 1114 may include, for example, microphones, alphanumeric keyboards, touchscreens, touchpads, and pointing devices (also called “cursor control devices”). The output device interface 1106 may enable, for example, the display of images generated by electronic system 1100. Output devices that may be used with the output device interface 1106 may include, for example, speakers, printers and display devices, such as a liquid crystal display (LCD), a light emitting diode (LED) display, an organic light emitting diode (OLED) display, a flexible display, a flat panel display, a solid state display, a projector, a light source, a haptic components, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes, such as the server 114 shown in FIG. 1, through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

In accordance with aspects of the disclosure, a method is provided that includes generating, by a device at which a learned embedding of a first audio sample is stored in connection with an encoded version of the first audio sample, an encoded version of a second audio sample; comparing, by the device, the encoded version of the second audio sample with the encoded version of the first audio sample; responsive to a determination that the encoded version of the second audio sample matches the encoded version of the first audio sample, providing the learned embedding of the first audio sample to a first machine learning model at the device; and responsive to a determination that the encoded version of the second audio sample is different from the encoded version of the first audio sample, generating, using the first machine learning model, a learned embedding of the second audio sample and providing the learned embedding of the second audio sample to the first machine learning model.

In accordance with aspects of the disclosure, an electronic device is provided that includes a memory storing a learned embedding of a first audio sample in connection with an encoded version of the first audio sample; and one or more processors configured to: generate an encoded version of a second audio sample; compare the encoded version of the second audio sample with the encoded version of the first audio sample; responsive to a determination that the encoded version of the second audio sample matches the encoded version of the first audio sample, provide the learned embedding of the first audio sample to a first machine learning model at the device; and responsive to a determination that the encoded version of the second audio sample is different from the encoded version of the first audio sample, generate, using the first machine learning model, a learned embedding of the second audio sample and providing the learned embedding of the second audio sample to the first machine learning model.

In accordance with aspects of the disclosure, a non-transitory computer-readable medium is provided storing instructions which, when executed by one or more processors, cause the one or more processors to perform operations that include generating, by a device at which a learned embedding of a first audio sample is stored in connection with an encoded version of the first audio sample, an encoded version of a second audio sample; compare, by the device, the encoded version of the second audio sample with the encoded version of the first audio sample; responsive to a determination that the encoded version of the second audio sample matches the encoded version of the first audio sample, providing the learned embedding of the first audio sample to a first machine learning model at the device; and responsive to a determination that the encoded version of the second audio sample is different from the encoded version of the first audio sample, generating, using the first machine learning model, a learned embedding of the second audio sample and providing the learned embedding of the second audio sample to the first machine learning model.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
generating, by a device at which a learned embedding of a first audio sample is stored in connection with an encoded version of the first audio sample, an encoded version of a second audio sample;
comparing, by the device, the encoded version of the second audio sample with the encoded version of the first audio sample;
responsive to a determination that the encoded version of the second audio sample matches the encoded version of the first audio sample, providing the learned embedding of the first audio sample to a first machine learning model at the device; and
responsive to a determination that the encoded version of the second audio sample is different from the encoded version of the first audio sample, generating, using a second machine learning model, a learned embedding of the second audio sample and providing the learned embedding of the second audio sample to the first machine learning model.

2. The method of claim 1, further comprising, prior to generating the encoded version of the second audio sample:
obtaining, from a microphone of the device, the first audio sample; and
generating, using the second machine learning model at the device, the learned embedding of the first audio sample.

3. The method of claim 2, further comprising, prior to generating the encoded version of the second audio sample:
providing the learned embedding of the first audio sample to a third machine learning model at the device; and
obtaining, by the device, a label for the first audio sample based on an output of the third machine learning model.

4. The method of claim 3, wherein generating the encoded version of the first audio sample comprises generating a hash of the first audio sample.

5. The method of claim 3, wherein the third machine learning model is the first machine learning model.

6. The method of claim 3, wherein the first machine learning model is a multi-label classifier.

7. The method of claim 3, wherein the first machine learning model is different from the third machine learning model.

8. The method of claim 7, wherein the first machine learning model comprises a fire alarm detector and wherein the third machine learning model comprises a carbon dioxide alarm detector.

9. The method of claim 3, further comprising storing the label for the first audio sample in connection with the encoded version of the first audio sample.

10. The method of claim 1, further comprising deleting, after a period of time, the learned embedding of the first audio sample and the encoded version of the first audio sample from the device.

11. The method of claim 1, further comprising, responsive to the determination that the encoded version of the second audio sample is different from the encoded version of the first audio sample:
storing the learned embedding of the second audio sample;
generating an encoded version of the second audio sample; and
storing the learned embedding of the second audio sample in connection with the encoded version of the second audio sample.

12. An electronic device, comprising:
a memory storing a learned embedding of a first audio sample in connection with an encoded version of the first audio sample; and
one or more processors configured to:
generate an encoded version of a second audio sample;
compare the encoded version of the second audio sample with the encoded version of the first audio sample;
responsive to a determination that the encoded version of the second audio sample matches the encoded version of the first audio sample, provide the learned embedding of the first audio sample to a first machine learning model at the electronic device; and
responsive to a determination that the encoded version of the second audio sample is different from the encoded version of the first audio sample, generate, using a second machine learning model, a learned embedding of the second audio sample and providing the learned embedding of the second audio sample to the first machine learning model.

13. The electronic device of claim 12, wherein the one or more processors are further configured to, prior to generating the encoded version of the second audio sample:
obtain, from a microphone of the electronic device, the first audio sample; and
generate, using the second machine learning model at the electronic device, the learned embedding of the first audio sample.

14. The electronic device of claim 13, wherein the one or more processors are further configured to, prior to generating the encoded version of the second audio sample:
provide the learned embedding of the first audio sample to a third machine learning model at the electronic device; and
obtain, by the electronic device, a label for the first audio sample based on an output of the third machine learning model.

15. The electronic device of claim 14, wherein the one or more processors are further configured to generate the encoded version of the first audio sample by generating a hash of the first audio sample.

16. The electronic device of claim 14, wherein the third machine learning model is the first machine learning model.

17. The electronic device of claim 14, wherein the first machine learning model is a multi-label classifier.

18. The electronic device of claim 14, wherein the first machine learning model is different from the third machine learning model.

19. The electronic device of claim 14, wherein the one or more processors are further configured to store, in the memory, the label for the first audio sample in connection with the encoded version of the first audio sample.

20. A non-transitory computer-readable medium storing instructions which, when executed by one or more processors, cause the one or more processors to perform operations comprising:
generating, by a device at which a learned embedding of a first audio sample is stored in connection with an encoded version of the first audio sample, an encoded version of a second audio sample;
compare, by the device, the encoded version of the second audio sample with the encoded version of the first audio sample;
responsive to a determination that the encoded version of the second audio sample matches the encoded version of the first audio sample, providing the learned embedding of the first audio sample to a first machine learning model at the device; and
responsive to a determination that the encoded version of the second audio sample is different from the encoded version of the first audio sample, generating, using a second machine learning model, a learned embedding of the second audio sample and providing the learned embedding of the second audio sample to the first machine learning model.
